(19) United States
(12) Patent Application Publication
(10) Pub. No.: US 2011/0135944 A1
(43) Pub. Date: Jun. 9, 2011

(54) THERMOSETTING COMPOSITION

(75) Inventor: Frans Setiabudi, Eschbach (DE)

(73) Assignee: Huntsman International LLC, The Woodlands, TX (US)

(21) Appl. No.: 13/058,354

(22) PCT Filed: Apr. 24, 2009
(86) PCT No.: PCT/EP2009/054976

§ 371 Date: Feb. 10, 2011

(30) Foreign Application Priority Data
Aug. 12, 2008 (EP) 08105017.1

(51) Int. Cl. C08G 73/06; C08G 75/02; C08G 75/20; C09J 171/00; B05D 3/10; B32B 15/08; B32B 21/08; B32B 17/00; B32B 27/08; B32B 27/06; B32B 27/26

(52) U.S. Cl. 428/446; 528/408; 528/373; 528/391; 528/409; 427/385.5; 156/331.5; 428/457; 428/537.1; 428/702; 428/698; 428/411.1

(57) ABSTRACT

A thermosetting composition comprising
(a) (a) at least one phosphorous-free dihydrobenzoxazine component;
(b) at least a sulfonium salt and
(c) optionally a compound comprising at least an epoxy group is disclosed.

Cured products made from these compositions have valuable chemical, physical and mechanical properties.

### TECHNICAL FIELD

This invention relates to thermosetting composition comprising at least one phosphorous-free dihydrobenzoxazine component and at least one sulfonium salt. The invention also relates to the use of said thermosetting composition for the manufacture of a moulded article or for a resin transfer moulding process as well as a surface coating, a composite, a laminate, a casting resin, prepregs, prepregs for printed wiring boards, coatings for pipes, a resin of a resin transfer moulding process, wings of planes, blades of rotors, a matrix resin for electronic components or automotive or aerospace applications, or an adhesive for electronic components or automotive or aerospace applications. Additionally, the invention concerns cured products manufactured from said thermosetting composition and a process for the manufacturing of articles.

### BACKGROUND OF THE INVENTION

Dihydrobenzoxazine components have been employed satisfactorily to produce prepregs, laminates, moulding materials, RTM (resin transfer moulding) systems, sealants, sinter powders, cast articles, structural composites parts, varnishes, surface coatings, electrical and electronic components by impregnating, coating, laminating or moulding processes.

Dihydrobenzoxazine components can easily be produced in several, well known ways by the reaction of bisphenols with a primary amine and formaldehyde, whereby the process can be carried out in the presence of solvents (see for example U.S. Pat. No. 5,152,993 or U.S. Pat. No. 5,266,695) or in the absence of solvents (see for example U.S. Pat. No. 5,543,516). Various hardeners such as novolacs, polyepoxides or polyamines are known to cure the dihydrobenzoxazine resin in order to obtain the valuable properties of the resins which make this class of thermosetting resins attractive.

EP 0 789 056 A2 describes a thermosetting resin composition with improved curability comprising dihydrobenzoxazines of polyphenols such as novolacs or bisphenol A and novolac phenolic resins. The composition is used as adhesives or for the manufacture of moulded articles, coatings, sealings, prepregs for printed wiring boards and metal-clad laminates with low water absorbance, improved none-flammability and high heat resistance. However, use of polyhydroxy functional novolacs as a hardener for the dihydrobenzoxazine resins lead sometimes to an undesirable high reactivity (low gel times) and, furthermore, to highly cross-linked resins, which generally are brittle.

WO 2006/035021 A1 describes bisdihydrobenzoxazines on the basis of phenolphthalein for the preparation of polymers, which show a high temperature stability and a good none-flammability. Polymerisation may be carried out in presence of catalysts, such as thiodipropionic acid, phenols or sulfonyl diphenol. However, the use of sulfonium salts as catalysts is not mentioned in WO 2006/035021 A1.

WO 02/057279 A1 discloses phosphorous containing dihydrobenzoxazine resin composition comprising epoxy resins and sulfonium salts as a possible hardener. However, the phosphorous containing dihydrobenzoxazine resin systems demonstrate a long gel time and a low reaction enthalpy which render said resin systems unsuitable for high reactive coating and moulding applications.

Especially for resin transfer molding processes it is desirable to be able to keep the thermosetting composition in a liquid or molten liquid state. Therefore, it is necessary that at this stage of the process the thermosetting composition does not cure rapidly. However, once the article is shaped it is desired that once the temperature is increased the thermosetting composition cures rapidly.

### SUMMARY OF THE INVENTION

It was an object of the present invention to provide a thermosetting composition which demonstrate a good balance between workability at increased temperatures and an increased reactivity. Furthermore, it was a further object of the present invention to provide a thermosetting composition which demonstrate an increased Tg which is especially important for applications in the automotive and aerospace industry.

It has now been surprisingly found that sulfonium salts are excellent catalysts for the polymerization of components containing at least one, preferably two dihydrobenzoxazine groups, especially bis(dihydrobenzoxazine) compounds. The thermosetting compositions obtained demonstrate a higher reactivity while the workability at increased temperature is maintained. Additionally, it has surprisingly been found that the thermosetting compositions demonstrate an unusual high latency and storage stability despite the increased reactivity. The thermosetting composition can therefore be stored in one container and shipped to users which is an economic advantage and much more comfortable for users. Additionally, the processability and control during molding operations such as pressing is improved which results in improved dimensional accuracy. Additionally, the processability and control during moulding operations such as pressing is improved which results in improved dimensional accuracy.

### DETAILED DESCRIPTION OF THE INVENTION

A first embodiment of the invention is a thermosetting composition comprising

(a) at least one phosphorous-free dihydrobenzoxazine component; and

(b) at least one sulfonium salt.

Component (a):

An essential component of the thermosetting composition according to the present invention is a phosphorous-free component (a) comprising at least one dihydrobenzoxazine group.

Preferably component (a) is a bis(dihydrobenzoxazine), i.e. a compound comprising two dihydrobenzoxazine groups.

More preferably component (a) is a bis(dihydrobenzoxazines) of formula (I),

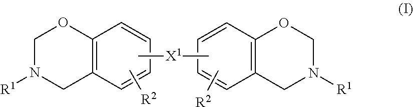

wherein

each R¹ is independently C₁-C₁₆ alkyl, C₃-C₁₂ cycloalkyl, C₃-C₁₂ cycloalkyl which is substituted with a C₁-C₄-alkyl; C₆-C₁₈ aryl which is unsubstituted or substituted by one or more C₁-C₆ alkyl groups or C₁-C₆ alkoxy groups;

each R² is independently hydrogen, dialkylamino; alkylthio; alkylsulfonyl; C₁-C₁₈ alkyl; C₁-C₁₈ alkenyl; C₁-C₁₈ alkoxy; C₁-C₁₈ alkoxy-C₁-C₁₆-alkylene; C₅-C₁₂ cycloalkyl which is unsubstituted or substituted by one or more C₁-C₆ alkyl groups or C₁-C₆ alkoxy groups; C₆-C₁₂ aryl which is unsubstituted or substituted by one or more C₁-C₆ alkyl groups or C₁-C₆ alkoxy groups; or C₆-C₁₂ aryl-C₁-C₁₈-alkylene wherein the aryl moiety is unsubstituted or substituted by one or more C₁-C₆ alkyl groups or C₁-C₆ alkoxy groups;

X¹ is a bivalent bridging group selected from —O—, —S—, —S(O)—, —S(O)₂—, —C(O)—, —N(R³)—,

—O—C(O)—, —O—C(O)—O—, —S(O)₂—O—, —O—S(O)₂—O—, C₁-C₁₈ alkenediyl, C₃-C₁₂ cycloalkylene, C₆-C₁₂ cycloalkenediyl, —Si(OR³)₂— and —Si(R³)₂—; and

R³ is H, C₁-C₁₂ alkyl, C₅ or C₆ cycloalkyl, C₅ or C₆ cycloalkyl substituted with methyl, ethyl, phenyl; benzyl or phenyleth-2-yl.

When the radicals R¹ to R³ are alkyl, alkoxy or alkoxy-alkylene, those alkyl, alkoxy or alkylene radicals can be straight-chained or branched and may contain 1 to 12, more preferably 1 to 8 and most preferably 1 to 4 C atoms.

Examples of alkyl groups are methyl, ethyl, isopropyl, n-propyl, n-butyl, isobutyl, sec-butyl, tert-butyl and the various isomeric pentyl, hexyl, heptyl, octyl, nonyl, decyl, undecyl, dodecyl, tridecyl, tetradecyl, pentadecyl, hexadecyl, heptadecyl and octadecyl.

Suitable alkoxy groups are, for example, methoxy, ethoxy, isopropoxy, n-propoxy, n-butoxy, isobutoxy, sec-butoxy, tert-butoxy and the various isomeric pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy and octadecyloxy.

Examples of alkoxy-alkylene groups are 2-methoxyethylene, 2-ethoxyethylene, 2-methoxypropylene, 3-methoxypropylene, 4-methoxybutylene and 4-ethoxybutylene.

Cycloalkyl is preferably C₅-C₈ cycloalkyl, especially C₅ or C₆ cycloalkyl. Some examples thereof are cyclopentyl, cyclopentyl substituted with methyl, cyclohexyl, cycloheptyl and cyclooctyl.

Aryl groups are, for example, phenyl, naphthyl and anthryl.

The aryl-alkylene group preferably contains from 7 to 12 carbon atoms and especially from 7 to 11 carbon atoms. It can be selected from the group consisting of benzyl, phenylethylene, 3-phenylpropylene, α-methylbenzyl, 4-phenylbutylene or α,α-dimethylbenzyl.

R¹ is preferably C₁-C₁₂ alkyl, C₅-C₈ cycloalkyl or C₅-C₈ cycloalkyl which is substituted by one or more C₁-C₄ alkyl groups or C₁-C₄ alkoxy groups, C₆-C₁₀ aryl which is unsubstituted or substituted by one or more C₁-C₄ alkyl groups or C₁-C₄ alkoxy groups.

In a more preferred embodiment of the present invention, R¹ is C₁-C₆alkyl; phenyl; benzyl; or phenyl or benzyl wherein the aryl moiety is substituted by one or more methyl groups or methoxy groups.

According to the invention, components of formula (I) are preferred, in which R¹ is isopropyl, iso- or tertiary-butyl, n-pentyl or phenyl.

R² in the component of formula (I) is preferably hydrogen.

Cycloalkylene X¹ may be a polycycloalkylene having 2 to 4 condensed and/or bridged carbon cycles such as bicyclo-[2,2,1]-heptanylene or tricyclo-[2,1,0]-decanylene.

X¹ is preferably a direct bond or more preferably a bivalent bridging group selected from —O—, —S—, —S(O)—, —S(O)₂—, —C(O)—, C₁-C₂ alkylene, and C₁-C₁₂ alkenediyl.

It was found that S containing bridging groups improve flammability resistance and these groups may be selected if said resistance is desired.

R³ is preferably H, C₁-C₁₂ alkyl, C₅ or C₆ cycloalkyl, C₅ or C₆ cycloalkyl substituted with methyl, ethyl, phenyl; benzyl or phenyleth-2-yl.

In a preferred embodiment, R³ is selected from C₁-C₄ alkyl, cyclohexyl, phenyl or benzyl.

According to a preferred embodiment of the present invention component (a) is a bis(dihydrobenzoxazine) prepared by the reaction of an unsubstituted or substituted bisphenol having at least one unsubstituted position ortho to each hydroxyl group, with formaldehyde and a primary amine.

Bis(dihydrobenzoxazines) on the basis of bisphenols are well known, commercially available and can be prepared according to well known and published methods.

The unsubstituted or substituted bisphenol is preferably selected from hydrochinone, resorcinol, catechol, or from bisphenols of formula (II),

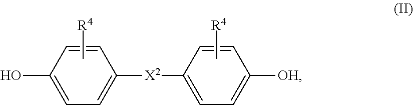

Wherein

R⁴ is independently hydrogen, dialkylamino; alkylthio; alkylsulfonyl; C₁-C₁₈ alkyl; alkenyl; C₁-C₁₈ alkoxy; C₁-C₁₈ alkoxy-C₁-C₁₈-alkylene; C₅-C₁₂ cycloalkyl which is unsubstituted or substituted by one or more C₁-C₈ alkyl groups or C₁-C₈ alkoxy groups; C₆-C₁₂ aryl which is unsubstituted or substituted by one or more C₁-C₆ alkyl groups or C₁-C₈ alkoxy groups; or C₆-C₁₂ aryl-C₁-C₁₈-alkylene wherein the aryl moiety is unsubstituted or substituted by one or more C₁-C₈ alkyl groups or C₁-C₆ alkoxy groups;

X² is a bivalent bridging group selected from —O—, —S—, —S(O)—, —S(O)₂—, —C(O)—, —N(R³)—,

—O—C(O)—, —O—C(O)—O—, —S(O)₂—O—, —O—S(O)₂—O—, C₁-C₁₈ alkylene, C₂-C₁₈ alkenediyl, C₃-C₁₂ cycloalkylene, C₅-C₁₂ cycloalkenediyl, —Si(OR³)₂— and —Si(R³)₂—; and

R³ is H, C₁-C₁₂ alkyl, C₅ or C₆ cycloalkyl, C₅ or C₆ cycloalkyl substituted with methyl, ethyl, phenyl; benzyl or phenyleth-2-yl.

R³ in formula (II) may independently have the same preferred meanings as R³ in formula (I).

R⁴ in formula (II) may independently have the same preferred meanings as R² in formula (I). R⁴ is in particular hydrogen or C₁-C₄ alkyl, such as methyl or ethyl.

X² preferably is a direct bond or a bivalent bridging group selected from —O—, —S—, —S(O)₂—,

—C(O)—, —N(R³), C₁-C₄ alkylene (for example methylene or 1,2-ethylene), C₂-C₆ alkenediyl (for example ethenediyl, 1,1- or 2,2-propenediyl, 1,1- or 2,2-butenediyl, 1,1-, 2,2- or 3,3-pentenediyl, or 1,1-, 2,2- or 3,3-hexenediyl) or C₅-C₅ cycloalkenediyl (for example cyclopentenediyl, cyclohexenediyl or cyclooctenediyl), whereby R³ is preferably hydrogen or C₁-C₄ alkyl.

If an improved flammability resistance is desired, X² is a bivalent bridging group selected from —S—, and —S(O)₂—.

Some preferred examples of bisphenols used to prepare bis(dihydrobenzoxazines) are 4,4′-dihydroxybiphenyl, (4-hydroxyphenyl)₂C(O) (DHBP), bis(4-hydroxyphenyl)ether, bis(4-hydroxyphenyl)thioether, bisphenol A, bisphenol AP, bisphenol E, bisphenol H, bisphenol F, bisphenol S, bisphenol Z, phenolphthalein and bis(4-hydroxyphenyl)tricyclo-[2,1,0]-decan.

According to a particularly preferred embodiment of the present invention component (a) is selected from the group consisting of components of formulae (III) to (XII)

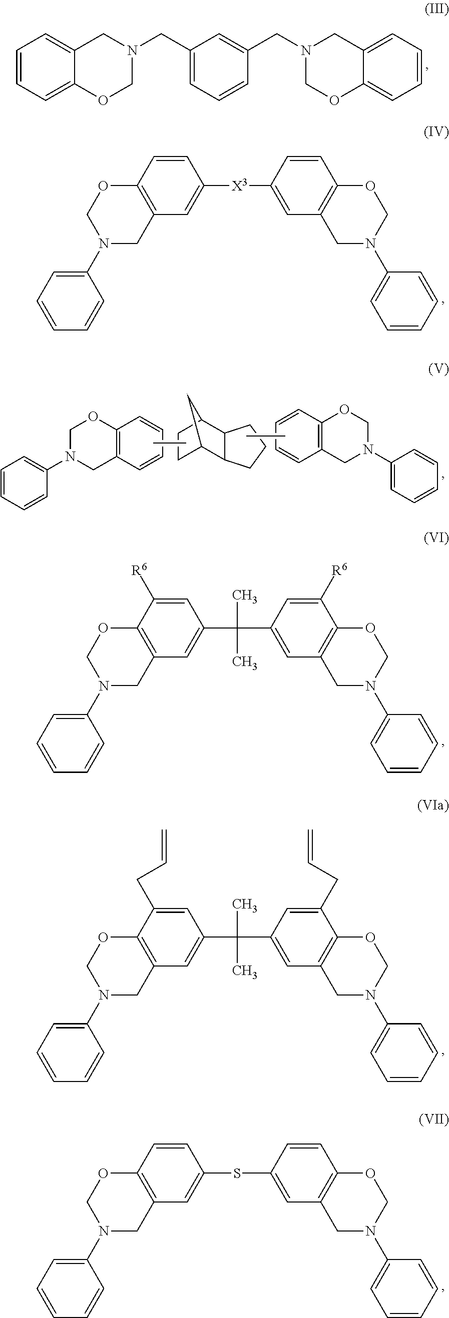

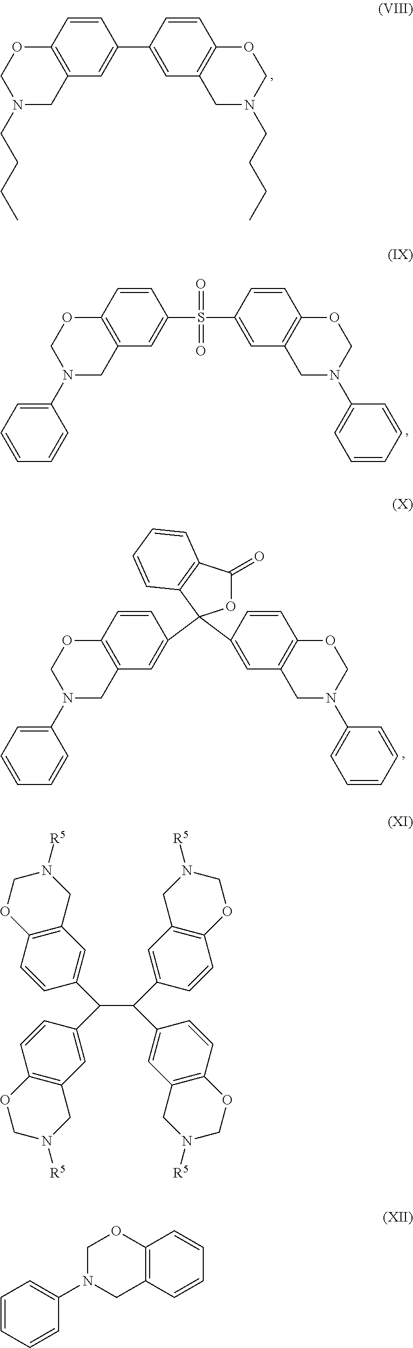

or any mixtures thereof

wherein X³ is a bivalent bridging group selected from —O—, —S—, —S(O)—, —S(O)₂—, —C(O)—, —N(R³)—, —O—C(O)—, —O—C(O)—O—, —S(O)₂—O—, —O—S(O)₂—O—, C₁-C₁₈ alkylene, C₂-C₁₈ alkenediyl, C₃-C₁₂ cycloalkylene, C₅-C₁₂ cycloalkenediyl, —Si(OR³)₂— and —Si(R³)₂—;

R³ is H, C₁-C₁₂ alkyl, C₅ or C₆ cycloalkyl, C₅ or C₆ cycloalkyl substituted with methyl, ethyl, phenyl; benzyl or phenyleth-2-yl;

R⁵ is independently C₁-C₁₈ alkyl, or C₃-C₁₂ cycloalkyl, C₃-C₁₂ cycloalkyl substituted with C₁-C₄ alkyl, C₆-C₁₈ aryl which is unsubstituted or substituted by one or more C₁-C₆ alkyl groups or C₁-C₆ alkoxy groups; and

R⁶ is independently H, etheneyl or allyl.

Component (b):

A further essential component of the thermosetting composition according to the present invention is component (b) which is a sulfonium salt.

The sulfonium salts can be obtained by methods disclosed in EP-A1-379464 and EP-A1-580552.

Preferably the sulfonium salt (b), is selected from a compound of formulae (XIII) to (XVIII)

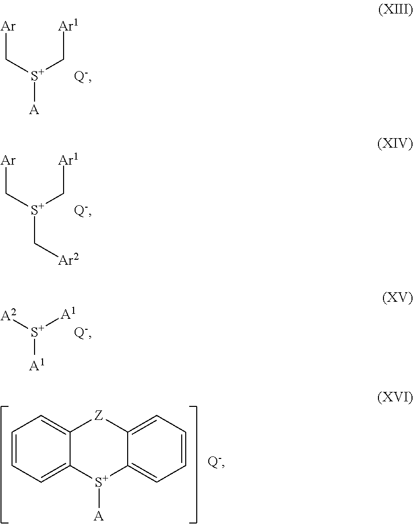

Ar—CH₂—S⁺(A)-CH₂-arylene-CH₂—S⁺(A)-CH₂—Ar¹ 2Q⁻ (XVII) or

Ar—CH₂—S⁺(—CH₂-A)-CH₂-arylene-CH₂—S⁺(—CH₂-A)-CH₂—Ar¹ 2Q⁻ (XVIII) or any mixture thereof, in which A is C₁-C₁₂ alkyl, C₃-C₈ cycloalkyl which is unsubstituted or mono- or polysubstituted by C₁-C₈ alkyl, C₄-C₁₀ cycloalkyl-alkylene, phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;

Ar, Ar¹ and Ar², independently of one another, are each phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms or is naphthyl which is unsubstituted or mono-or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;

arylene is phenylene which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms or naphthylene which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;

Q is BF₄, PF₆, SbF₆, AsF₆, SbF₆OH or CF₃SO₃;

A¹ has independently the meaning of Ar;

A² is C₁-C₁₂ alkyl, C₃-C₈ cycloalkyl which is unsubstituted or mono- or polysubstituted by C₁-C₈ alkyl, or C₄-C₁₀ cycloalkyl-alkylene; and

Z is a single bond, —O—, —S—, —S⁺(AQ⁻)- wherein A and Q have the same meaning as mentioned above, —C(O)— or —CH₂—.

Component (b) is preferably a sulfonium salt of the formulae (XIII) or (XIV)

in which A is C₁-C₁₂ alkyl, C₃-C₈ cycloalkyl, C₄-C₁₀ cycloalkyl-alkylene, phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;

Ar, Ar¹ and Ar², independently of one another, are each phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms, or is naphthyl which is unsubstituted or mono-or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;

A¹ has independently the meaning of Ar,

A² C₁-C₁₂ alkyl, C₃-C₈ cycloalkyl, C₄-C₁₀ cycloalkyl-alkylene, and

Q is SbF₆, AsF₆ or SbF₅ OH.

Preferably, A is C₁ -C₁₂ alkyl or phenyl which is unsubstituted or substituted by halogen or C₁-C₄ alkyl.

Ar, Ar¹ and Ar², independently of one another, are each phenyl which is unsubstituted or mono- or polysubstituted by C₁-C₈ alkyl, C₁-C₄ alkoxy, Cl or Br, and Q is SbF₆ or SbF₅OH, for example dibenzylethylsulfonium hexafluoroantimonate.

Particularly preferred sulfonium salts are those of the formula (XIII) in which A, Ar¹ and Ar², independently of one another, are each phenyl which is unsubstituted or substituted by C₁-C₈ alkyl, C₁-C₄ alkoxy, Cl or Br and Q is SbF₆ or SbF₅OH, such as in particular dibenzylphenylsulfonium hexafluoroantimonate.

C₁-C₁₂ alkyl as A can be straight-chain or branched. For example, A can be methyl, ethyl, isopropyl, n-butyl, sec-butyl, tert-butyl, n-octyl or n-dodecyl.

Examples of suitable cycloalkyls are cyclopropyl, cyclopentyl, cyclohexyl, and cyclooctyl.

Examples of suitable cycloalkyl-alkylenes are cyclohexyl-methylene and cyclohexyl-ethylene.

A substituted phenyl or naphthyl as A, Ar, Ar¹ and Ar² can be identically or differently substituted phenyl or naphthyl. Examples are p-tolyl, xylyl, ethylphenyl, methoxyphenyl, ethoxyphenyl, p-chlorophenyl, 2,4-, 3,4- or 2,6-dichlorophenyl, bromophenyl, acetylphenyl, trimethylphenyl, methylnaphthyl, methoxynaphthyl, ethoxynaphthyl, chloronaphthyl, bromonaphthyl and biphenyl.

A substituted phenylene or naphthylene as arylene can be, for example, methylphenylene, ethylphenylene, methoxyphenylene, ethoxyphenylene, chlorophenylene, dichlorophenylene, bromophenylene, acetylphenylene, trimethylphenylene, methylnaphthylene, methoxynaphthylene, ethoxynaphthylene, chloronaphthylene or bromonaphthylene. Preferably, arylene is an unsubstituted phenylene or naphthylene.

Examples of the aromatic sulfonium salt of the formula (XIII) are preferably selected from the group consisting of benzyl-4-hydroxyphenylmethylsulfonium hexafluoroantimonate, benzyl-4-hydroxyphenyl-methyl-sulfonium hexafluorophosphate, 4-acetoxyphenylbenzylmethyl-sulfonium hexafluoro-antimonate, 4-acetoxyphenyldimethylsulfonium hexafluoroantimonate, benzyl-4-methoxy-phenylmethylsulfonium hexafluoroantimonate, benzyl-2-methyl-4-hydroxy-phenyl methylsulfonium hexafluoroantimonate, benzyl-3-chloro-4-hydroxyphenylmethyl-sulfonium hexafluoro-arsenate, benzyl-3-methyl-4-hydroxy-5-tert-butylphenylmethylsulfonium hexafluoroantimonate, 4-methoxybenzyl-4-hydroxyphenylmethylsulfonium hexafluoro-phosphate, dibenzyl-4-hydroxyphenylsulfonium hexafluoroantimonate, dibenzyl-4-hydroxy-phenylsulfonium hexafluorophosphate, 4-acetoxyphenyldibenzylsulfonium hexafluoro-antimonate, dibenzyl-4-methoxyphenylsulfonium hexafluoroantimonate, nitrobenzyl-4-hydroxyphenylimethylsulfonium hexafluoroantimonate, 3,5-dinitrobenzyl-4-hydroxyphenyl-methylsulfonium hexafluoro-antimonate and β-naphthylmethyl-4-hydroxyphenylmethyl-sulfonium hexafluoroantimonate. An example of compounds of formula (XV) is diphenyl-cyclohexylsulfonium hexafluoroantimonate.

Commercially available aromatic sulfonium salts of the formula (XIII) include, for example, Sanaid® SI-L85, Sanaid® SI-L110, Sanaid® SI-L145, Sanaid® SI-L160, Sanaid® SI-H15, Sanaid® SI-H20, Sanaid® SI-H25, Sanaid® SI-H40, Sanaid® SI-H50, Sanaid® SI-60L, Sanaid® SI-80L, Sanaid® SI-100L, Sanaid® SI-80, and Sanaid® SI-100 (trademarks, products of Sanshin Chemical Industry KK).

Component (c):

The thermosetting composition according to the present invention can additionally comprise component (c) which is a compound comprising at least one epoxy group.

It has been found that thermosetting compositions comprising the components (a), (b) and (c) demonstrate a significantly improved reactivity which lead to thermally cured products having a high glass transition temperature (Tg).

The epoxy resins and, in particular, the di- and polyepoxides and epoxy resin prepolymers of the type used for the preparation of crosslinked epoxy resins are especially important. The di- and polyepoxides can be aliphatic, cycloaliphatic or aromatic compounds. Illustrative examples of such compounds are the glycidyl ethers and f3-methyl glycidyl ethers of aliphatic or cycloaliphatic diols or polyols, typically those of ethylene glycol, 1,2-propanediol, 1,3-propanediol, 1,4-butanediol, diethylene glycol, polyethylene glycol, polypropylene glycol, glycerol, trimethylolpropane or 1,4-dimethylolcyclohexane or of 2,2-bis(4-hydroxycyclohexyl)propane, the glycidyl ethers of di- and polyphenols, typically resorcinol, 4,4′-dihydroxydiphenylmethane, 4,4′-dihydroxydiphenyl-2,2-propane, novolaks and 1,1,2,2-tetrakis(4-hydroxyphenyl)ethane.

Other industrially important glycidyl compounds are the glycidyl esters of carboxylic acids, preferably of di- and polycarboxylic acid. Illustrative examples thereof are the glycidyl esters of succinic acid, adipic acid, azelaic acid, sebacic acid, phthalic acid, terephthalic acid, tetra- and hexahydrophthalic acid, isophthalic acid or trimellitic acid, or of dimerised fatty acids.

Exemplary of polyepoxides that differ from glycidyl compounds are the diepoxides of vinyl cyclohexene and dicyclopentadiene, 3-(3′,4′-epoxycyclohexyl)-8,9-epoxy-2,4-dioxaspiro[5.5]undecane, the 3′,4′-epoxycyclohexylmethyl ester of 3,4-epoxycyclohexanecarboxylic acid, butadiene diepoxide or isoprene diepoxide, epoxidised linoleic acid derivatives or epoxidised polybutadiene.

Preferred epoxy resins are diglycidyl ethers or advanced diglycidyl ethers of dihydroxy phenols or of dihydroxa aliphatic alcohols containing 2 to 4 carbon atoms. Particularly preferred epoxy resins are the diglycidyl ethers or advanced diglycidyl ethers of 2,2-bis(4-hydroxyphenyl)propane and bis(4-hydroxyphenyl)methane.

According to a preferred embodiment of the present invention the thermosetting composition comprises at least one cycloaliphatic epoxy component. Cycloaliphatic epoxy components selected from the group of components which are represented by the following formulae (XIX) to (XXIII) are especially preferred

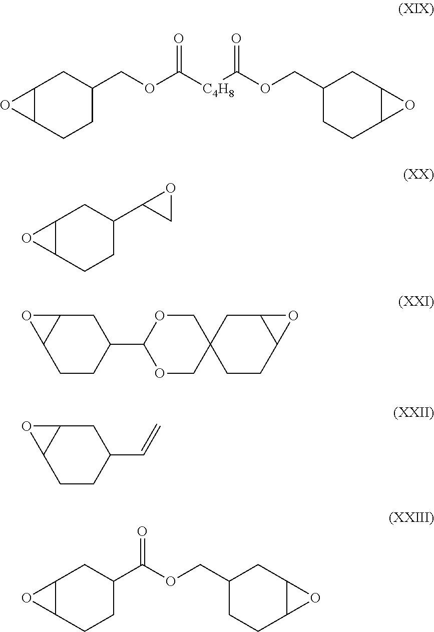

Most preferred is the cycloaliphatic epoxy component which is represented by formula (XXIII).

According to a preferred embodiment of the present invention the thermosetting composition comprises an epoxy component (component (c)) which is liquid at 25° C. The liquid epoxy components can be used as reactive diluents and improve the workability of thermosetting compositions. Preferably, the thermosetting composition comprises at least one epoxy component which has a viscosity up to 2500 mPa·s, more preferably up to 1000 mPa·s, especially between 50 and 1000 mPa·s, for example between 150 and 500 mPa·s (measured as dynamic viscosity at 25° C. according to ISO 12058-1:1997).

According to a preferred embodiment of the present invention the thermosetting composition comprises the components (a), (b) and (c) and the weight ratio of component (b) to the sum of components (a) and (c) is 1:1000 to 1:10.

Preferably, the weight ratio of component (a) to epoxy group containing component (c) is 95:5 to 10:90.

Further preferably is a thermosetting composition wherein the weight ratio of component (a) to sulfonium salt (b) is 100:1 to 10:1.

Preferred is a thermosetting composition wherein the weight ratio of phosphorous-free component comprising at least one dihydrobenzoxazine groups (a) to epoxy compound (c) is 95:5 to 10:90.

The properties of the thermosetting resins can be tailored for certain applications by addition of usual additives. The following additives are of particular importance:

reinforcement fibers, such as glass, quartz, carbon, mineral and synthetic fibers (Keflar, Nomex), natural fibres, such as flax, jute, sisal, hemp in the usual forms of short fibers, staple fibers, threads, fabrics or mats; plasticizers, especially phosphorus compounds; mineral fillers, such as oxides, carbides, nitrides, silicates and salts, e.g. quartz powder, fused silica, aluminium oxide, glass powder, mica, kaolin, dolomite,carbon black or graphite; pigments and dyestuffs; micro hollow spheres; metal powders; flame retardants; defoaming agents; slip agents; viscosity modifier; adhesion promoters; and mould release agents.

The thermosetting composition according to the invention can also comprise a solvent or a solvent mixture, especially when it is used as laminating or surface coating composition. Examples of solvents which are particularly suitable are selected from the group consisting of methylethylketone, acetone, N-methyl-2-pyrrolidone, N,N-dimethyl formamide, pentanol, butanol, dioxolane, isopropanol, methoxy propanol, methoxy propanol acetate, dimethylformamide, glycols, glycol acetates, toluene and xylene. The ketones and the glycols are especially preferred. Typically, the laminating composition comprises 20 to 30% by weight of solvent, based on the total weight of the composition.

The thermosetting composition according to the invention can be cured or pre-cured at temperatures of about 130 to 200° C., preferably 150 to 200° C. and in particular 160 to 180° C. for the manufacture of prepregs, laminates or hot melting moulding processes.

A further embodiment of the present invention is the use of the thermosetting composition according to present invention for a surface coating, a composite, a laminate, a casting resin, prepregs, prepregs for printed wiring boards, coatings for pipes, a resin of a resin transfer moulding process, wings of planes, blades of rotors, a matrix resin or adhesisve for electronic components or a resin for automotive or aerospace applications.

The thermosetting compositions according to the invention can be used, for example, as solvent-free casting resins, surface coating resins, laminating resins, moulding resins, pultrusion resins, encapsulating resins and adhesives to produce moulded or coated articles or composites for the electrical and electronic industry, in the automotive and aerospace industry, or for surface protection of many articles, e.g. pipes and pipelines.

A further embodiment of the present invention is the use of the thermosetting composition according to the present invention for the manufacture of a moulded article or for a resin transfer moulding process.

It is especially preferred to use the thermosetting composition according to the invention for the manufacture of composites from prepregs or B stage resins, and RTM (resin transfer moulding) systems.

Curing of the composition and an impregnation and lamination process is explained in the following:

The thermosetting composition according to the present invention is applied to or impregnated into a substrate by rolling, dipping, spraying or other known techniques and/or combinations thereof. The substrate is typically a woven or nonwoven fiber mat containing, for instance, glass fibers, carbon or mineral fibers or paper.

The impregnated substrate is “B-staged” by heating at a temperature sufficient to evaporate solvent (if the latter is present) in the thermosetting composition and to partially cure the benzoxazin formulation, so that the impregnated substrate can be handled easily. The “B-staging” step is usually carried out at a temperature of from 80° C. to 190° C. and for a time of from 1 minute to 15 minutes. The impregnated substrate that results from “B-staging” is called a “prepreg”. The temperature is most commonly 90° C. to 110° C. for composites and 130° C. to 190° C. for electrical laminates.

One or more sheets of prepreg are stacked on top of each other or may alternate with one or more sheets of a conductive material, such as copper foil, if an electrical laminate is desired.

The laid-up sheets are pressed at high temperature and pressure for a time sufficient to cure the resin and form a laminate. The temperature of this lamination step is usually between 100° C. and 240° C., and is most often between 165° C. and 190° C. The lamination step may also be carried out in two or more stages, such as a first stage between 100° C. and 150° C. and a second stage at between 165° C. and 190° C. The pressure is usually from 50 N/cm² and 500 N/cm². The lamination step is usually carried out for a time of from 1 minute to 200 minutes, and most often for 45 minutes to 90 minutes. The lamination step may optionally be carried out at higher temperatures for shorter times (such as in continuous lamination processes) or for longer times at lower temperatures (such as in low energy press processes).

Optionally, the resulting laminate, for example, a copper-clad laminate, may be post-treated by heating for a time at high temperature and ambient pressure. The temperature of post-treatment is usually between 120° C. and 250° C. The post-treatment time usually is between 30 minutes and 12 hours.

Solid substrates for coating purposes may be selected from metal, metal alloys, wood, glass, minerals such as silicates, corundum or boron nitride, and plastics.

The cured resins possess a high chemical resistance, corrosion resistance, mechanical resistance, durability, hardness, toughness, flexibility, temperature resistance or stability (high glass transition temperatures), reduced combustibility, adhesion to substrates and de-lamination resistance.

A further embodiment of the present invention is a cured product manufactured from the thermosetting composition according to the present invention.

A further embodiment of the present invention is a process for the manufacturing of articles comprising the steps:

providing a fabric

impregnating the fabric with a thermosetting composition according to present invention and

curing the impregnated fabric.

### EXAMPLES

The following examples explain the invention.

Preparation of Thermosetting Compositions

Example A1 to A8 and Comparative Examples C1 to C7:

A mixture of (in parts by weight) component (a) dihydrobenzoxazine, component (b) sulfonium salt and optionally epoxy compound (c) is molten at 130-140° C., if necessary, and mixed under thorough stirring. The gel time of such homogenous mixture is measured on an hot plate at 190° C. The mixture is cured in an oven at 190° C. for 120 minutes and subsequently cured at 220° C. for further 120 min (see Examples A1 to A6 as well as comparative Examples C1 to C3). Examples C4, C5, C7, A7 and A9 have been cured in an oven at 220° C. for 3 hours whereas Examples C6 and A8 which are based on the mono dihydrobenzoxazine (5) have been cured at 180° C. for 3 h in order to avoid evaporation/decomposition of the respective composition.

The results are given in the following Tables 1 to 4.

Table 1 shows Examples A1 to A6 according to the present invention. A1 to A6 demonstrate relatively short gel times upon heating which is due to the high reactivity. Unusual high glass transition temperatures result, especially when epoxy compounds have additionally been used. Further the difference between the temperature at which the exothermal curing can be observed in the DSC (onset T) and the temperature at which the maximum speed of the reaction can be observed is relatively small. This behaviour makes the thermosetting compositions according to the present invention especially useful for resin transfer moulding processes in which a certain liquefied state is desired to form the shape of the desired article to be formed and during the subsequent curing process a rapid curing is desired which leads to cured resins with high glass transition temperatures (Tg after cure).

Table 1 demonstrates thermosetting compositions according to the present invention. The amounts of components referred to are mentioned in part per weight.

TABLE 1

| Component | A1 | A2 | A3 | A4 | A5 | A6 |
|---|---|---|---|---|---|---|
| dihydrobenzoxazine (1) | 4 | 5 | | | | |
| dihydrobenzoxazine (2) | | | 5 | | | 4 |
| dihydrobenzoxazine (3) | | | | 5 | | |
| dihydrobenzoxazine (4) | | | | | 5 | |
| diphenyl- | 0.12 | | | | | |
| cyclohexylsulfonium | | | | | | |
| hexafluoroantimonate | | | | | | |
| 3,4- | 1 | | | | | 1 |
| epoxycyclohexylmethyl- | | | | | | |
| 3,4-epoxy- | | | | | | |
| cyclohexanecarboxylate | | | | | | |
| bisphenol A epoxy resin | | | | | | |
| di-benzyl-phenyl | | 0.1 | 0.1 | 0.1 | 0.1 | 0.12 |
| sulfonium-antimonium- | | | | | | |
| hexafluorate | | | | | | |
| gel time @ 190° C. | 620 s | 412 s | 352 s | 611 s | 540 s | 522 s |
| DSC 30-350; 20° C./min | | | | | | |
| onset T[° C.] | 203 | 202 | 205 | 215 | 202 | 212 |
| peak T[° C.] | 243 | 226 | 240 | 235 | 238 | 247 |
| enthalpy [J/g] | 323 | | 226 | 314 | 170 | 284 |
| Tg after 2 h@190° C. | 194 | 168 | 187 | 178 | 155 | 195 |
| enthalpy [J/g] | 38 | 29 | 66 | 32 | 22 | 85 |
| Tg after 2 h at 190° C. | 209 | 175 | 208 | 178 | 197 | 240-256 |
| and 2 h at 220° C. | | | | | | |

Dihydrobenzoxazine (1) corresponds to formula (IV) with X³ = —CH₂— (bisphenol F based dihydrobenzoxazine)
Dihydrobenzoxazine (2) corresponds to formula (X) (phenolphthaleine based dihydrobenzoxazine
Dihydrobenzoxazine (3) corresponds to formula (VI) with R⁶ = H (bisphenol A based dihydrobenzoxazine)
Dihydrobenzoxazine (4) corresponds to formula (V) (dicyclopentadiene based dihydrobenzoxazine)

Table 2 shows Example A2 which is a thermosetting composition according to the present invention and which is compared with thermosetting composition (C1 to C3) comprising a phosphorous containing dihydrobenzoxazine. The amounts of components referred to are mentioned in parts per weight.

TABLE 2

| | C1 | C2 | C3 | |
|---|---|---|---|---|
| Component | (comparative) | (comparative) | (comparative) | A2 |
| dihydrobenzoxazine | 5 | 5 | 5 | |
| (6) | | | | |
| dihydrobenzoxazine | | | | 5 |
| (1) | | | | |
| dibenzyl-phenyl- | | 0.1 | 0.5 | 0.1 |
| sulfonium | | | | |
| hexafluoroantimonate | | | | |
| gel time @ 190° C. | 40 min. | 21 min | 9 min | 7 min |
| DSC 30-350; | | | | |
| 20° C./min | | | | |
| onset T [° C.] | 175/239 )² | 188 | 169/274 )² | 202 |
| peak T [° C.] | 184/273 )² | 240/324 )² | 202/306 )² | 226 |
| enthalpy [J/g] | 23/81 | 45/48 | 52/55 | 287 |
| Tg after 2 h @ 190° C. | )¹ | 103 | )¹ | 168 |
| enthalpy [J/g] | )¹ | 95 | )¹ | 29 |
| Tg after 2 h at 190° C. | )¹ | 142 | )¹ | 175 |
| and 2 h at 220° C. | | | | |

)¹ not possible to determine due to decomposition
)² two peaks observed
Dihydrobenzoxazine (1) corresponds to formula (IV) with X³ = —CH₂— (bisphenol F based dihydrobenzoxazine)
Dihydrobenzoxazine (6) corresponds to formula (XXIV) which is a phosphorous containing dihydrobenzoxazine disclosed in WO 02/057279 A1.

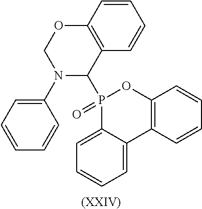

The comparative examples C1 to C3 show higher gel times as well as lower glass transition temperatures after cure compared to the thermosetting composition according to the present invention A2. Additionally, the comparative examples C1 and C3 decomposed upon heating.

Table 3 shows Examples A7 and A8 which are thermosetting compositions according to the present invention and which are compared with thermosetting compositions C4 and C6 respectively which are compositions not comprising sulfonium salts. Additionally, A7 is compared with comparative example C5 which is a mixture comprising a phosphorous free dihydrobenzoxazine and the commonly used curing catalyst 2-methylimidazole. The amounts of components referred to are mentioned in parts per weight.

TABLE 3

| | C4 | C5 | | C6 | |
|---|---|---|---|---|---|
| Component | (comparative) | (comparative) | A7 | (comparative) | A8 |
| dihydrobenzoxazine (5) | | | | 100 | 3.9 |
| dihydrobenzoxazine (1) | 100 | 3.9 | 3.9 | | |
| 2-methylimidazol | | 0.1 | | | |
| dibenzyl-phenyl sulfonium- | | | 0.1 | | 0.1 |
| antimonium-hexafluorate | | | | | |
| gel time at 190° C. [sec] | 1320 | 308 | 360 | 1033 | 386 |
| DSC 30-350; 20° C./min | | | | | |
| T onset | 239 | 179 | 198 | 266 | 209 |
| peak T | 254 | 219 | 222 | 273 | 224 |
| enthalpy [J/g] | 293 | 271 | 269 | 225 | 281 |
| Tg [° C.] after 3 h at 220° C. | 172 | 174 | 188 | | |
| Tg [° C.] after 3 h at 180° C. | | | | 116 | 116 |

Dihydrobenzoxazine (1) corresponds to formula (IV) with X³ = —CH₂— (bisphenol F based dihydrobenzoxazine).
Dihydrobenzoxazine (5) corresponds to formula (XII) (phenol based dihydrobenzoxazine).

Comparison of C4 with A7 and C6 with A8 show that by using the sulfonium salt a lower gel time as well as a lower temperature for the start of the exothermal curing (T onset) could be observed. Further, A7 compared to C4 led to a higher Tg after cure at 220° C.

Likewise, the comparison of C5 with A7 shows the advantage of using a sulfonium salt as a curing catalyst instead of a catalyst commonly used in the prior art. A7 demonstrate a significantly higher Tg after cure and the difference between the temperature at which the exothermal curing can be observed in the DSC (T onset) and the temperature at which the maximum speed of the reaction can be observed is significantly smaller than for comparative example C5.

Table 4 shows Example A9 which is a thermosetting composition according to the present invention and which are compared with a thermosetting composition C7 which is a composition comprising a phosphorous free dihydrobenzoxazine and the commonly used curing catalyst 2-methylimidazole. The amounts of components referred to are mentioned in part per weight.

TABLE 4

| | C7 | |
|---|---|---|
| Component | (comparative) | A9 |
| dihydrobenzoxazine (1) | 3.9 | 3.9 |
| 3,4-epoxycyclohexylmethyl-3,4-epoxy- | 1 | 1 |
| cyclohexanecarboxylate | | |
| 2-methylimidazol | 0.1 | |
| dibenzyl-phenyl sulfonium- | | 0.1 |
| antimonium-hexafluorate | | |
| gel time @ 190° C. [sec] | 218 | 789 |
| DSC 30-350; 20° C./min | | |
| T onset | 183/255 ) ² | 210 |
| peak T | 219/274 ) ² | 247 |
| enthalpy [J/g] | 214/87 | 175 |
| Tg [° C.] after 3 h/220° C. | 190 | 209 |

) ² two peaks observed
Dihydrobenzoxazine (1) corresponds to formula (IV) with X³ = —CH₂— (bisphenol F based dihydrobenzoxazine)

Comparison of C7 with A9 shows the advantage of using a sulfonium salt as a curing catalyst instead of a catalyst commonly used in the prior art. A9 demonstrate a significantly higher Tg after cure and the difference between the temperature at which the exothermal curing can be observed in the DSC (T onset) and the temperature at which the maximum speed of the reaction can be observed is significantly smaller than for comparative example C7. Further, the DSC measurement of C7 revealed two peaks for the T onset as well as the peak T (maximum of the peak) which shows a not desirably stepwise reaction with a high difference between T onset (183° C.) and peak T (274° C.).

1. A thermosetting composition comprising
(a) at least one phosphorous-free dihydrobenzoxazine component; and
(b) at least one sulfonium salt.

2. A thermosetting composition according to claim 1, wherein component (a) is a bis(dihydrobenzoxazine).

3. A thermosetting composition according to claim 2, wherein component (a) is a bis(dihydrobenzoxazine) prepared by the reaction of an unsubstituted or substituted bisphenol having at least one unsubstituted position ortho to each hydroxyl group, with formaldehyde and a primary amine.

4. A thermosetting composition according to claim 2, wherein component (a) is a bis(dihydrobenzoxazine) of formula (I), 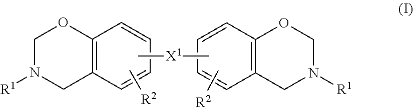
wherein
each R¹ is Independently C₁-C₁₈ alkyl, C₃-C₁₂ cycloalkyl, C₃-C₁₂ cycloalkyl which is substituted with a C₁-C₄-alkyl; C₆-C₁₈ aryl which is unsubstituted or substituted by one or more C₁-C₆ alkyl groups or C₁-C₆ alkoxy groups;
each R² is independently hydrogen, dialkylamino; alkylthio; alkylsulfonyl; C₁-C₁₈ alkyl; C₁-C₁₈ alkenyl; C₁-C₁₈ alkoxy; C₁-C₁₈ alkoxy-C₁-C₁₈-alkylene; C₅-C₁₂ cycloalkyl which is unsubstituted or substituted by one or more C₁-C₆ alkyl groups or C₁-C₆ alkoxy groups; C₆-C₁₂ aryl which is unsubstituted or substituted by one or more C₁-C₆ alkyl groups or C₁-C₆ alkoxy groups; or C₆-C₁₂ aryl-C₁-C₁₈-alkylene wherein the aryl moiety is unsubstituted or substituted by one or more C₁-C₆ alkyl groups or C₁-C₆ alkoxy groups;
X¹ is a bivalent bridging group selected from —O—, —S—, —S(O)—, —S(O)₂—, —C(O)—, —N(R³)—, —O—C(O)—, —O—C(O)—O—, —S(O)₂—O—, —O—S(O)₂—O—, C₁-C₁₈ alkylene, C₂-C₁₈ alkenediyl, C₃-C₁₂ cycloalkylene, C₅-C₁₂ cycloalkenediyl, —Si(OR³)₂— and —Si(R³)₂—; and
R³ is H, C₁-C₁₂ alkyl, C₅ or C₆ cycloalkyl, C₅ or C₆ cycloalkyl substituted with methyl, ethyl, phenyl; benzyl or phenyleth-2-yl.

5. A thermosetting composition according to claim 1 wherein component (a) is selected from the group consisting of components of formulae (III) to (XII) 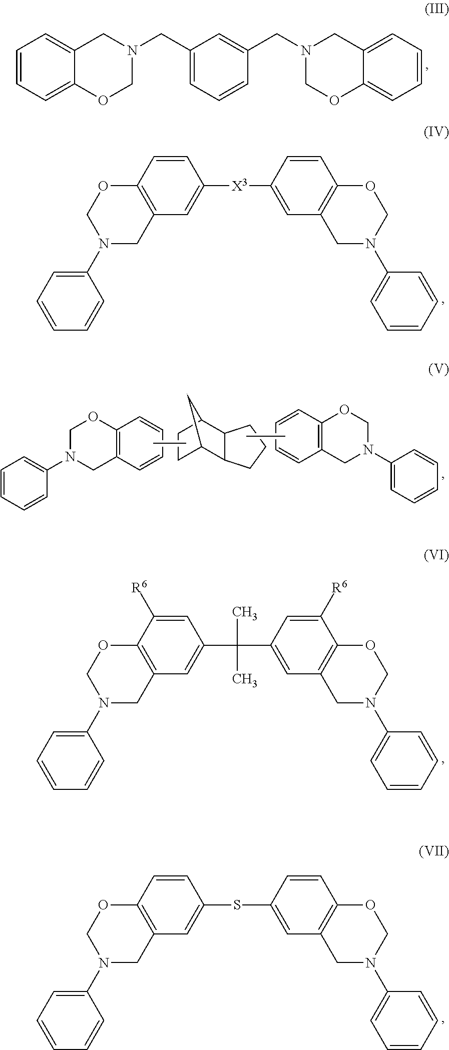 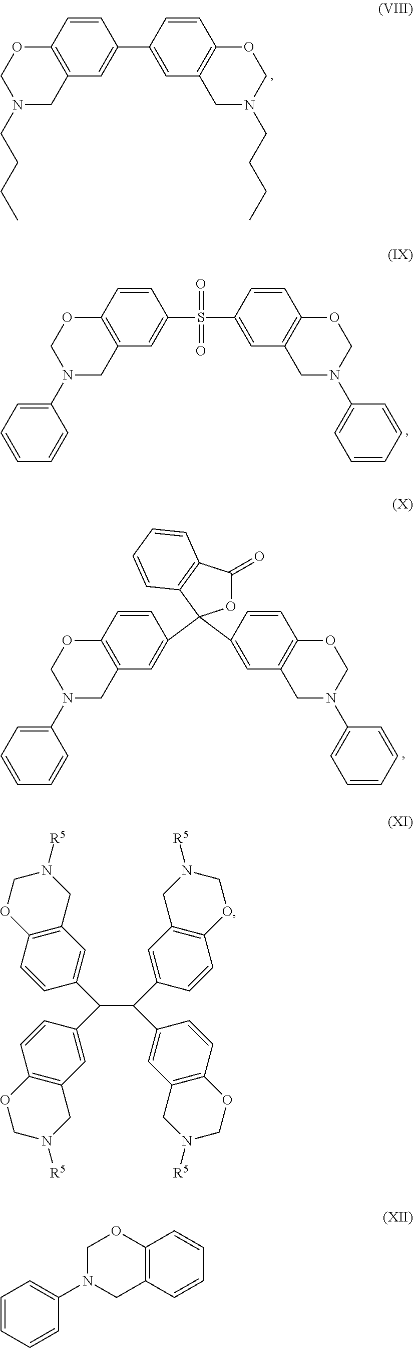
and any mixtures thereof
wherein X³ is a bivalent bridging group selected from —O—, —S—, —S(O)—, —S(O)₂—, —C(O)—, —N(R)³—, —O—C(O)—, —O—C(O)—O—, —S(O)₂—O—, —O—SC₂—O—, C₁-C₁₈ alkylene, C₂-C₁₈ alkenediyl, C₃-C₁₂ cycloalkylene, C₅-C₁₂ cyclo alkenediyl, —Si(OR³)₂— and —Si(R³)₂—;
R³ is H, C₁-C₁₂ alkyl, C₅ or C₆ cycloalkyl, C₅ or C₆ cycloalkyl substituted with methyl, ethyl, phenyl; benzyl or phenyleth-2-yl;
R⁵ is independently C₁-C₁₈ alkyl, or C₃-C₁₂ cycloalkyl, C₃-C₁₂ cycloalkyl substituted with C₁-C₄ alkyl, C₆-C₁₈ aryl which is unsubstituted or substituted by one or more C₁-C₆ alkyl groups or C₁-C₆ alkoxy groups; and
R⁶ is independently H, etheneyl or allyl.

6. A composition according to claim 1, wherein the sulfonium salt (b), is selected from the group consisting of compounds of formulae (XIII) to (XVIII) 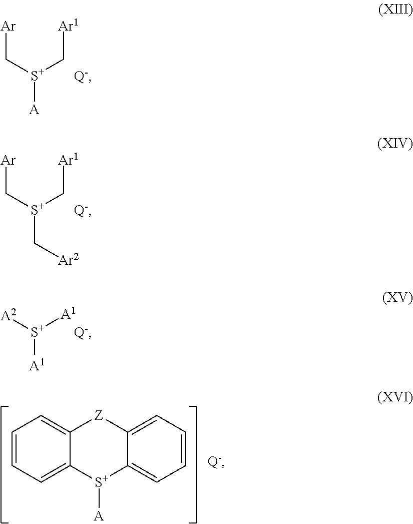
Ar—CH₂—S⁺(A)-CH₂-arylene-CH₂—S⁺(A)-CH₂—Ar¹ 2Q⁻ (XVII),
Ar—CH₂—S⁺(—CH₂-A)-CH₂-arylene-CH₂—S⁺(—CH₂-A)-CH₂—Ar¹ 2Q⁻ (XVIII)
and any mixture thereof, in which A is C₁-C₁₂ alkyl, C₃-C₈ cycloalkyl which is unsubstituted or mono- or polysubstituted by C₁-C₈ alkyl, C₄-C₁₀ cycloalkyl-alkylene, phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;
Ar, Ar¹ and Ar², independently of one another, are each phenyl which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms or is naphthyl which is unsubstituted or mono-or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;
arylene is phenylene which is unsubstituted or mono- or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms or naphthylene which is unsubstituted or mono-or polysubstituted by C₁-C₈ alkyl, C₁-C₄ alkoxy, halogen, nitro, phenyl, phenoxy, alkoxycarbonyl having 1-4 C atoms in the alkoxy radical or acyl having 1-12 C atoms;
Q is BE₄, PF₆, SbF₆, AsF₆, SbF₅OH or CF₃SO₃;
A¹ has independently the meaning of Ar;
A² is C₁-C₁₂ alkyl, C₃-C₈ cycloalkyl which is unsubstituted or mono- or polysubstituted by C₁-C₈ alkyl, or C₄-C₁₀ cycloalkyl-alkylene; and
Z is a single bond, —O—, —S—, —S⁺(AQ⁻)- wherein A and Q have the same meaning as mentioned above, —C(O)— or —CH₂—.

7. A thermosetting composition according to claim 1 additionally comprising at least one epoxy group containing component (c).

8. A thermosetting composition according to claim 7 wherein the weight ratio of component (b) to the sum of components (a) and (c) is 1:1000 to 1:10.

9. A thermosetting composition according to claim 7 wherein component (c) is a cycloaliphatic epoxy component.

10. A thermosetting composition according to claim 7 wherein the weight ratio of component (a) to epoxy group containing component (c) is 95:5 to 10:90.

11. A thermosetting composition according to claim 1 wherein weight ratio of component (a) to sulfonium salt (b) is 100:1 to 10:1.

12-13. (canceled)

14. A method for manufacturing a cured product comprising curing the thermosetting composition according to claim 1 at a temperature of about 130° to 200° C.

15. Process for the manufacturing of articles comprising the steps:
a) providing a fabric
b) impregnating the fabric with a thermosetting composition according to claim 1
c) curing the impregnated fabric.

16. A process for the manufacturing of a laminate comprising:
(a) impregnating a substrate with the thermosetting composition according to claim 1;.
(b) heating the impregnated substrate to partially cure the thermosetting composition and form a prepreg;
(c) stacking one or more sheets of prepreg on top of each other;
(d) pressing the stacked sheets at a temperature and pressure sufficient to cure the thermosetting composition and form a laminate; and.
(e) optionally, post-treating the laminate by applying heat to the laminate.

17. A method for coating a solid substrate comprising applying the thermosetting resin composition of claim 1 to the solid substrate.

18. The method according to claim 17, wherein the solid substrate is selected from metal, metal alloys, wood, glass, minerals, corundum, boron nitride, and plastics
